(19) United States
(12) Patent Application Publication
(10) Pub. No.: US 2002/0159755 A1
(43) Pub. Date: Oct. 31, 2002

(54) Decoder, decoding method, re-encoder, re-encoding method, decoding program and re-encoding program embodied on computer-readable meduim

(75) Inventor: Kazuo Kuroda, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/131,217

(22) Filed: Apr. 25, 2002

(30) Foreign Application Priority Data
Apr. 27, 2001 (JP) P2001-133466

(51) Int. Cl. H04N 7/08; H04N 7/52

(52) U.S. Cl. 386/94; 386/95

(57) ABSTRACT

When decoding encoded information encoded according to an MPEG method to generate decoded information, a superimposition unit generates the decoded information by embedding identification information in a still image reproduced from an I picture contained in a GOP constituting the encoded information, the identification information indicating that the still image is obtained by decoding the I picture. In re-encoding, the identification information is detected from the generated decoded information, and the decoded information is encoded again with reference to the still image having contained the identification information.

### BACKGROUND OF THE INVENTION

1. Field of the Invention

The present invention relates to a technical field of a decoder, a decoding method, a re-encoder, a re-encoding method, an information recording medium, a decoding program and a re-encoding program, and more specifically, a decoder and a decoding method for decoding information once encoded, a re-encoder and a re-encoding method for encoding again the decoded information, a decoding program and a re-encoding program for the decoding process and the re-encoding process, and an information recording medium having the programs recorded therein.

2. Description of the Related Art

In recent years, the so-called MPEG method has become popular as an international standard for compressing and encoding a motion image composed of a plurality of still images.

In the composition of the motion image, which is compressed and encoded according to the MPEG method, the so-called GOP (Group of Picture) is the minimum accessible unit. Each GOP contains a plurality of types of 15 encoded still images (hereinafter, the encoded still image will be referred to as a “picture”), and thus, a motion image encoded as a whole is composed.

Now, the pictures contained in the GOP will be described. The pictures include ones described below.

That is, one GOP contains three types of pictures: an I picture (Intra-coded picture); a P picture (Predictive-coded picture); and a B picture (Bidirectionally predictive-coded picture).

The I picture refers to a picture that can be decoded to reproduce a complete still image using only the picture itself.

The P picture refers to a prediction image that is decoded by decoding a difference between itself and a prediction image reproduced through complementation using a decoded I picture or another P picture.

Furthermore, the B picture refers to a prediction image that is decoded by using not only an I picture or P picture decoded prior to the B picture but also an I picture or P picture following the B picture.

When the encoded motion image composed of the pictures is to be decoded, the P picture and the B picture are decoded by referring to the decoded I picture, another P picture or the like as described above. In European Patent EP0618734 (corresponding to Japanese Patent Laid-Open No.6-284414), for example, there is disclosed a technique of incorporating into the still image constituting the motion image and obtained as a result of such decoding, that is, each of the still images obtained by decoding the above-described pictures information indicative of what type of picture the still image is reproduced from.

In the technique disclosed in the European Patent, when decoding the encoded motion image, the information indicative of the type of the picture decoded to reproduce each of the still images constituting the motion image after decoding is incorporated in the vertical blanking interval of the still image. Furthermore, there is disclosed a technique of decoding an encoded motion image by handling it as digital information, and describing the information indicative of the type of the picture decoded to reproduce each of the still images constituting the motion image after decoding in a format associated with the still image.

However, in the case where each of the still images decoded according to the decoding method disclosed in the European Patent is encoded again, if the information indicative of the type of the picture is incorporated in the vertical blanking interval, the information is susceptible to the effect of a noise reduction circuit often used in the re-encoding, and cannot be used for transmission as digital information after the re-encoding.

In the case where the information indicative of the type of the picture is described in the format as digital information, if the still image is converted into another format during the re-encoding, the original information indicative of the type of picture may be erased.

Therefore, in both cases, the information indicative of the type of the picture cannot be used in the re-encoding, resulting in the problem of degradation in the quality of the re-encoded still image.

### SUMMARY OF THE INVENTION

Thus, the present invention is devised in view of the above-described problems, and an object of the present invention is to provide a decoder and decoding method that can minimize degradation in the quality of information even when encoded information obtained by encoding a motion image or the like is repeatedly decoded and re-encoded, a re-encoder and a re-encoding method for conducting the re-encoding, a decoding program for the decoding embodied on computer-readable medium, a re-encoding program for the re-encoding embodied on computer-readable medium.

The above object of the present invention can be achieved by a decoder of the present invention for generating decoded information by decoding encoded information. The decoder is provided with: a detection device for detecting a status of encoding in the encoded information based on the encoded information; and a generation device for generating the decoded information by embedding status information indicative of the detected status in image information contained in the decoded information.

According to the present invention, since the decoded information is generated by embedding the status information in the image information, re-encoding the decoded information by using the status information embedded therein enables the quality of information after being re-encoded to be improved compared with the case where the re-encoding does not involve usage of the status information.

Therefore, even when the encoded information is repeatedly decoded and re-encoded, the degradation in the quality of the information can be minimized.

In addition, since the decoded information is generated by embedding the status information in the image information, the status information is not lost in the re-encoding.

In one aspect of the present invention, the generation device embeds the status information in the image information only when copy of the encoded information is permitted to be executed.

According to this aspect, since the re-encoding using the status information can be accomplished only when the decoded information is permitted to be duplicated, the quality of the decoded information, which is permitted to be duplicated, after being re-encoded can be improved.

In addition, since the status information cannot be used when the copy is not permitted, the quality of the information cannot be maintained in the re-encoding in the case where the decoded information not permitted to be duplicated is illegally duplicated, and consequently, the copy of the decoded information can be restricted.

In another aspect of the present invention, the generation device embeds dummy information different from the status information in the image information only when copy of the encoded information is prohibited from being executed.

According to this aspect, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, the generation device embeds the status information in the image information by digital watermarking.

According to this aspect, since the status information is embedded in the image information by digital watermarking, the status information can be prevented from being lost in the re-encoding while enhancing the secrecy of the status information.

In further aspect of the present invention, the generation device embeds the dummy information in the image information by digital watermarking.

According to this aspect, since the dummy information is embedded in the image information by digital watermarking, the dummy information can be prevented from being lost in the re-encoding, and consequently, illegal re-encoding of the decoded information can be effectively suppressed.

The above object of the present invention can be achieved by a decoder of the present invention for generating decoded information by decoding encoded information containing copy control information that restricts copy of the decoded information obtained by decoding the encoded information. The decoder is provided with: a detection device for detecting a status of encoding in the encoded information based on the encoded information; and a generation device for generating the decoded information by superimposing status information indicative of the detected status thereon only when the copy control information is the copy control information for permitting the copy to be executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding using the status information can be accomplished only when the decoded information is permitted to be duplicated, the quality of the decoded information, which is permitted to be duplicated, after being re-encoded can be improved, and the status information cannot be used when the copy is not permitted. Therefore, the quality of the information cannot be maintained in the re-encoding in the case where the decoded information not permitted to be duplicated is illegally duplicated, and consequently, the copy of the decoded information can be restricted.

The above object of the present invention can be achieved by a decoder of the present invention for generating decoded information by decoding encoded information containing copy control information is that restricts copy of the decoded information obtained by decoding the encoded information. The decoder is provided with: a detection device for detecting a status of encoding in the encoded information based on the encoded information; and a generation device for generating the decoded information by superimposing dummy information different from the detected status information indicative of the detected status thereon only when the copy control information is the copy control information for prohibiting the copy from being executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, the encoded information is compressed motion image information comprising a plurality of compressed still images, and the status information is type information indicative of the type of the still image.

According to this aspect, since the status information indicates the type of the still image constituting the compressed motion image information, the re-encoding of the decoded information can be controlled according to the type of the still image, so that the quality of the motion image after being re-encoded can be improved compared with the case where the re-encoding does not involve usage of the type information.

In further aspect of the present invention, the compressed motion image information is compressed according to an MPEG (Moving Picture Experts Group) method, and the type information indicates that the still image is an intra-coded picture.

According to this aspect, since the compressed motion image information is compressed according to the MPEG method and the type information is one indicating that the still image is an intra-coded picture, the re-encoding can be accomplished with reference to the intra-coded picture with a high quality.

The above object of the present invention can be achieved by a re-encoder of the present invention for encoding again decoded information generated by the decoder for generating decoded information by decoding encoded information, the decoder comprising: a detection device for detecting a status of encoding in the encoded information based on the encoded information; and a generation device for generating the decoded information by embedding status information indicative of the detected status in image information contained in the decoded information. The re-encoder is provided with: a detection device for detecting status information from the decoded information; and an encoding device for encoding again the decoded information using the detected status information.

According to the present invention, since the decoded information is encoded again by using the status information detected therefrom, the quality of the information after being re-encoded can be improved compared with the case where the re-encoding does not involve usage of the status information.

In addition, since the decoded information is generated by embedding the status information in the image information, the status information is not lost in the re-encoding.

The above object of the present invention can be achieved by a decoding method of the present invention for generating decoded information by decoding enabled information. The method is provided with: a detecting process of detecting a status of encoding in the encoded information based on the encoded information; and a generating process of generating the decoded information by embedding status information indicative of the detected status in image information contained in the decoded information.

According to the present invention, since the decoded information is generated by embedding the status information in the image information, re-encoding the decoded information by using the status information embedded therein enables the quality of information after being re-encoded to be improved compared with the case where the re-encoding does not involve usage of the status information.

Therefore, even when the encoded information is repeatedly decoded and re-encoded, the degradation in the quality of the information can be minimized.

In addition, since the decoded information is generated by embedding the status information in the image information, the status information is not lost in the re-encoding.

In one aspect of the present invention, in the generating process, the status information is embedded in the image information only when copy of the encoded information is permitted to be executed.

According to this aspect, since the re-encoding using the status information can be accomplished only when the decoded information is permitted to be duplicated, the quality of the decoded information, which is permitted to be duplicated, after being re-encoded can be improved.

In addition, since the status information cannot be used when the copy is not permitted, the quality of the information cannot be maintained in the re-encoding in the case where the decoded information not permitted to be duplicated is illegally duplicated, and consequently, the copy of the decoded information can be restricted.

In another aspect of the present invention, in the generating process, dummy information different from the status information is embedded in the image information only when copy of the encoded information is prohibited from being executed.

According to this aspect, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, in the generating process, the status information is embedded in the image information by digital watermarking.

According to this aspect, since the status information is embedded in the image information by digital watermarking, the status information can be prevented from being lost in the re-encoding while enhancing the secrecy of the status information.

In further aspect of the present invention, in the generating process, the dummy information is embedded in the image information by digital watermarking.

According to this aspect, since the dummy information is embedded in the image information by digital watermarking, the dummy information can be prevented from being lost in the re-encoding, and consequently, illegal re-encoding of the decoded information can be effectively suppressed.

The above object of the present invention can be achieved by a decoding method of the present invention for generating decoded information by decoding encoded information containing copy control information that restricts copy of the decoded information obtained by decoding the encoded information. The method is provided with: a detecting process of detecting a status of encoding in the encoded information based on the encoded information; and a generating process of generating the decoded information by superimposing status information indicative of the detected status thereon only when the copy control information is the copy control information for permitting the copy to be executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding using the status information can be accomplished only when the decoded information is permitted to be duplicated, the quality of the decoded information, which is permitted to be duplicated, after being re-encoded can be improved, and the status information cannot be used when the copy is not permitted. Therefore, the quality of the information cannot be maintained in the re-encoding in the case where the decoded information not permitted to be duplicated is illegally duplicated, and consequently, the copy of the decoded information can be restricted.

The above object of the present invention can be achieved by a decoding method of the present invention for generating decoded information by decoding encoded information containing copy control information that restricts copy of the decoded information obtained by decoding the encoded information. The method is provided with: a detecting process of detecting a status of encoding in the encoded information based on the encoded information; and a generating process of generating the decoded information by superimposing dummy information different from the detected status information indicative of the detected status thereon only when the copy control information is the copy control information for permitting the copy to be executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, the encoded information is compressed motion image information composed of a plurality of compressed still images, and the status information is type information indicative of the type of the still image.

According to this aspect, since the status information indicates the type of the still image constituting the compressed motion image information, the re-encoding of the decoded information can be controlled according to the type of the still image, so that the quality of the motion image after being re-encoded can be improved compared with the case where the re-encoding does not involve usage of the type information.

In further aspect of the present invention, the compressed motion image information is compressed according to an MPEG method, and the type information indicates that the still image is an intra-coded picture.

According to this aspect, since the compressed motion image information is compressed according to the MPEG method and the type information is one indicating that the still image is an intra-coded picture, the re-encoding can be accomplished with reference to the intra-coded picture with a high quality.

The above object of the present invention can be achieved by a re-encoding method of the present invention for encoding again decoded information generated by a decoder for generating decoded information by decoding encoded information. The method is provided with: a detecting process of detecting status information from the decoded information; and an encoding process of encoding again the decoded information using the detected status information.

According to the present invention, since the decoded information is encoded again by using the status information detected therefrom, the quality of the information after being re-encoded can be improved compared with the case where the re-encoding does not involve usage of the status information.

In addition, since the decoded information is generated by embedding the status information in the image information, the status information is not lost in the re-encoding.

The above object of the present invention can be achieved by an information recording medium of the present invention having a decoding program recorded therein so as to be read by a decoding computer included in a decoder that generates decoded information by decoding encoded information. The decoding program causes the decoding computer to function as: a detection device for detecting a status of encoding in the encoded information based on the encoded information; and a generation device for generating the decoded information by embedding status information indicative of the detected status in image information contained in the decoded information.

According to the present invention, since the decoded information is generated by embedding the status information in the image information, re-encoding the decoded information by using the status information embedded therein enables the quality of information after being re-encoded to be improved compared with the case where the re-encoding does not involve usage of the status information.

Therefore, even when the encoded information is repeatedly decoded and re-encoded, the degradation in the quality of the information can be minimized.

In addition, since the decoded information is generated by embedding the status information in the image information, the status information is not lost in the re-encoding.

In one aspect of the present invention, the generation device embeds the status information in the image information only when copy of the encoded information is permitted to be executed.

According to this aspect, since the re-encoding using the status information can be accomplished only when the decoded information is permitted to be duplicated, the quality of the decoded information, which is permitted to be duplicated, after being re-encoded can be improved.

In addition, since the status information cannot be used when the copy is not permitted, the quality of the information cannot be maintained in the re-encoding in the case where the decoded information not permitted to be duplicated is illegally duplicated, and consequently, the copy of the decoded information can be restricted.

In another aspect of the present invention, the generation device embeds dummy information different from the status information in the image information only when copy of the encoded information is prohibited from being executed.

According to this aspect, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, the generation device embeds the status information in the image information by digital watermarking.

According to this aspect, since the status information is embedded in the image information by digital watermarking, the status information can be prevented from being lost in the re-encoding while enhancing the secrecy of the status information.

In further aspect of the present invention, the generation device embeds the dummy information in the image information by digital watermarking.

According to this aspect, since the dummy information is embedded in the image information by digital watermarking, the dummy information can be prevented from being lost in the re-encoding, and consequently, illegal re-encoding of the decoded information can be effectively suppressed.

The above object of the present invention can be achieved by an information recording medium of the present invention having a decoding program recorded therein so as to be read by a decoding computer included in a decoder that generates decoded information by decoding encoded information containing copy control information that restricts copy of the decoded information obtained by decoding the encoded information. The decoding program causes the decoding computer to function as: a detection device for detecting a status of encoding in the encoded information based on the encoded information; and a generation device for generating the decoded information by superimposing status information indicative of the detected status thereon only when the copy control information is the copy control information for permitting the copy to be executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding using the status information can be accomplished only when the decoded information is permitted to be duplicated, the quality of the decoded information, which is permitted to be duplicated, after being re-encoded can be improved, and the status information cannot be used when the copy is not permitted. Therefore, the quality of the information cannot be maintained in the re-encoding in the case where the decoded information not permitted to be duplicated is illegally duplicated, and consequently, the copy of the decoded information can be restricted.

The above object of the present invention can be achieved by an information recording medium of the present invention having a decoding program recorded therein so as to be read by a decoding computer included in a decoder that generates decoded information by decoding encoded information containing copy control information that restricts copy of the decoded information obtained by decoding the encoded information. The decoding program causes the decoding computer to function as: a detection device for detecting a status of encoding in the encoded information based on the encoded information; and a generation device for generating the decoded information by superimposing dummy information indicative of the detected status thereon only when the copy control information is the copy control information for prohibiting the copy from being executed.

According to the present invention, since the decoded information having the status information superimposed thereon is generated, the decoded information is re-encoded by using the superimposed status information, so that the quality of the information after being re-encoded can be improved compared with the case where the re-encoding does not involve usage of the status information.

In addition, since the re-encoding is accomplished by using the dummy information different from the status information only when the decoded information is prohibited from being duplicated, the quality of the information cannot be maintained in the re-encoding in the case where the decoded information not permitted to be duplicated is illegally duplicated, and consequently, the copy of the decoded information can be restricted.

In further aspect of the present invention, the encoded information is compressed motion image information composed of a plurality of compressed still images, and the status information is type information indicative of the type of the still image.

According to this aspect, since the status information indicates the type of the still image constituting the compressed motion image information, the re-encoding of the decoded information can be controlled according to the type of the still image, so that the quality of the motion image after being re-encoded can be improved compared with the case where the re-encoding does not involve usage of the type information.

In further aspect of the present invention, the compressed motion image information is compressed according to an MPEG method, and the type information indicates that the still image is an intra-coded picture.

According to this aspect, since the compressed motion image information is compressed according to the MPEG method and the type information is one indicating that the still image is an intra-coded picture, the re-encoding can be accomplished with reference to the intra-coded picture with a high quality.

The above object of the present invention can be achieved by an information recording medium of the present invention having a re-encoding program therein so as to be read by an encoding computer included in a re-encoder that encodes again decoded information generated by the decoder for generating decoded information by decoding encoded information, comprising: a detection device for detecting a status of encoding in the encoded information based on the encoded information; and a generation device for generating the decoded information by embedding status information indicative of the detected status in image information contained in the decoded information. The re-encoding program causes the encoding computer to function as: a detection device for detecting status information from the decoded information; and an encoding device for encoding again the decoded information using the detected status information.

According to the present invention, since the decoded information is encoded again by using the status information detected therefrom, the quality of the information after being re-encoded can be improved compared with the case where the re-encoding does not involve usage of the status information.

In addition, since the decoded information is generated by embedding the status information in the image information, the status information is not lost in the re-encoding.

### BRIEF DESCRIPTION OF THE DRAWINGS

FIG. 1 a diagram showing an example of a plurality of pictures constituting one GOP;

FIG. 2 is a block diagram showing a schematic configuration of a set-top box according to a first embodiment;

FIG. 3 is a flow chart illustrating a decoding process according to the first embodiment;

FIG. 4 is a schematic diagram illustrating a status of a motion image before and after the decoding process according to the first embodiment; and

FIG. 5 is a block diagram showing a schematic configuration of a recorder/player according to the first embodiment.

### DETAILED DESCRIPTION OF THE PREFERRED EMBODIMENTS

Now, a preferred embodiment of the present invention will be described with reference to the drawings.

The embodiment described below is an embodiment of the invention applied to an AV (Audio/Visual) system which is provided with: a set-top box serving as a decoder for decoding a motion image compressed and encoded according to the MPEG method described above and distributed on a broadcasting radio wave; and a recorder/player including an information recording apparatus for encoding the decoded motion image again and recording the motion image on an optical disc.

(I) Embodiment of GOP

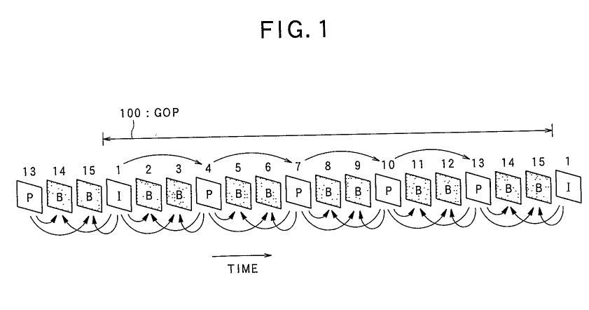

Before describing a specific embodiment, a configuration of the above-described GOP, that is, a configuration of the GOP constituting the compressed and encoded motion image distributed to the set-top box will be described with reference to FIG. 1. FIG. 1 shows an example of a plurality of pictures constituting one GOP.

The motion image in the distribution stage is composed of information units referred to as video packs, each of which contains one or more GOP. FIG. 1 shows a case where one GOP 100 is composed of 15 pictures substantially equivalent to 0.5 seconds of replay time. This number of pictures is illustrative, and one GOP 100 may contain various numbers of pictures in the MPEG method.

The 15 pictures include one leading I picture, and four P pictures and ten B pictures in the order shown in FIG. 1, which have a prediction relationship (interpolation relationship) therebetween indicated by arrows in FIG. 1.

In the MPEG method, a variable rate encoding method in which quantity of data contained in each GOP is varied is adopted.

Specifically, if the pictures in one GOP is provided for a fast original motion image and the correlation between the pictures is low, the quantity of data for constructing each of the pictures is increased, so that the quantity of data contained in one GOP 100 is increased.

On the other hand, if the pictures in one GOP 100 is provided for an original motion image that is poor in motion and the correlation between the pictures is high, the quantity of data for constructing each of the pictures is reduced, so that the quantity of data contained in one GOP 100 is reduced.

As described above, according to the MPEG method, since the still images constituting the motion image are encoded on a GOP-by-GOP basis, the motion image can be edited per the GOP 100 as the minimum unit, and since one P picture is contained per a preset number of B pictures, the original motion image can be compressed and encoded with a high compressibility.

(II) Embodiment of AV System

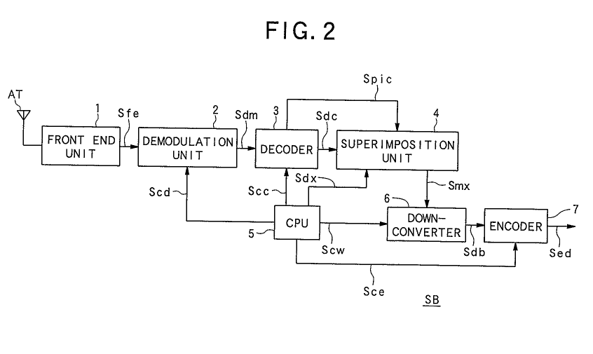

Next, an embodiment of an AV system according to this invention will be described with reference to FIGS. 2 to 5.

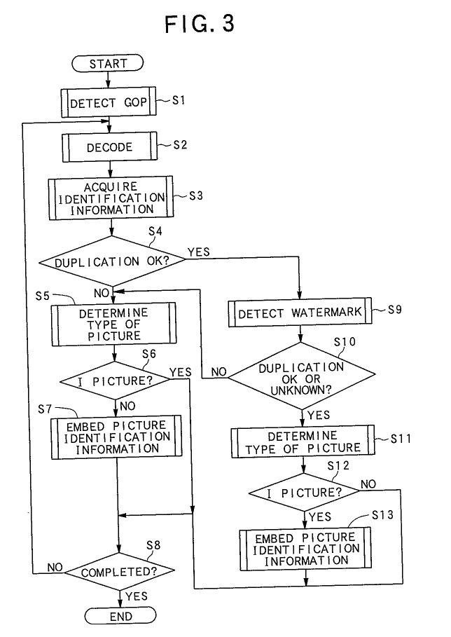

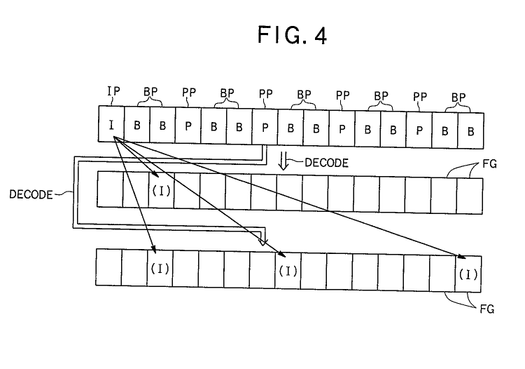

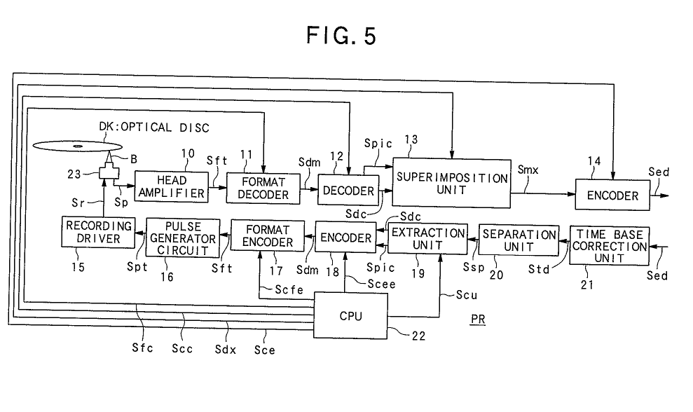

FIG. 2 is a block diagram showing a schematic configuration of a set-top box according to this embodiment, FIG. 3 is a flow chart illustrating a decoding process conducted in the set-top box, FIG. 4 is a schematic diagram illustrating a status of the motion image before and after the decoding process, and FIG. 5 is a block diagram showing a schematic configuration of a recorder/player according to this embodiment.

As shown in FIG. 2, a set-top box SB according to this embodiment is provided with a front end unit 1 having an antenna AT; a demodulation unit 2; a decoder 3 serving as a detection device; a superimposition unit 4 serving as a generation device; a CPU 5; a down-converter 6; and an encoder 7.

Now, a schematic operation thereof will be described.

First, the motion image information and audio information associated therewith that are distributed after compression and encoding are received by the antenna AT, subject to a preset receipt processing such as amplification in the front end unit 1, and output to the demodulation unit 2 in the form of a reception signal Sfe.

Then, based on a control signal Scd from the CPU 5, the demodulation unit 2 performs a descrambling process for decryption and a demultiplexing process for separating the motion image information from the audio information on the output reception signal Sfe, and outputs a demodulated signal Sdm to the decoder 3. At this time, the separated motion image information contained in the demodulated signal Sdm contains the above-described GOP 100.

Furthermore, based on a control signal Scc from the CPU 5, the decoder 3 decodes the motion image information and the audio information contained in the demodulated signal Sdm according to the MPEG method to generate a decoded signal Sdc containing the encoded motion image information and audio information and outputs the decoded signal Sdc to the superimposition unit 4.

Simultaneously, for the still images in the decoded motion image information, the decoder 3 outputs to the superimposition unit 4 a picture signal Spic, which is information indicative of the still image reproduced from the I picture in the GOP 100 before being decoded.

In this way, based on the picture signal Spic and a control signal Sdx from the CPU 5 and according to watermark method, the superimposition unit 4 embeds the picture signal Spic in the still image (decoded still image) in the decoded signal Sdc input at the time when the picture signal Spic is generated and outputs a superimposed signal Smx to the down-converter 6.

Then, based on a control signal Scw from the CPU 5, the down-converter 6 converts the decoded motion image information contained in the superimposed signal Smx into an image signal conforming to the NTSC (National Television System Committee) and outputs a converted signal Sdb to the encoder 7.

Finally, the encoder 7 performs a demodulation or the like according to the NTSC method on the converted signal Sdb and outputs an output signal Sed to a recorder/player described in detail later.

In parallel with this process, the CPU 5 generates the respective control signals described above to control comprehensively the operation of the set-top box SB.

Next, the decoding process according to this embodiment conducted in the decoder 3 and the superimposition unit 4 will be described with reference to FIGS. 2 to 4.

The decoding process is conducted on the assumption that the motion image information and the audio information received via the front end unit 1 are composed of information sectors each containing the motion image itself or sound itself composed of the above-described video packs, respectively, the information sector contains, at the head thereof, identification information indicative of whether or not the motion image information and the audio information are prohibited from being duplicated into another information recording medium or the like after being decoded, and the identification information is embedded also in the motion image information and the audio information themselves (that is, part other than the identification information) according to the watermark method.

As shown in FIG. 2, in the decoding process mainly conducted in the decoder 3 and the superimposition unit 4, first, the decoder 3 detects the head of each GOP 100 contained in the demodulated signal Sdm generated in the demodulation unit 2 (step S1), and then conducts the decoding process for the detected GOP 100 (step S2).

Specifically, in the detection of the GOP 100, the detection of the head of one GOP 100 attained by detecting the I picture contained in the demodulated signal Sdm is regarded as the detection of the GOP 100.

Then, the identification information contained at the head of the information sector, which is an information unit of the demodulated information Smd before being decoded is detected (step S3), and based on the identification information, it is determined whether or not the motion image information and the audio information input in the form of the demodulated information Sdm are those prohibited from being duplicated (step S4).

Then, as a result of the determination based on the identification information, if it is determined that the motion image information and the audio information input in the form of the demodulated information Sdm are those permitted to be duplicated (if YES in step S4), then, the identification information embedded in the motion image information or audio information itself as a watermark as the assumption for the decoding process of the first embodiment as described above is detected (step S9), and based on the detected identification information, it is determined whether the motion image information or the audio information is permitted to be duplicated or it is unknown due to a failure in detection of the watermark whether the copy is permitted or not (step S10).

If it is determined that the motion image information and the audio information are not permitted to be duplicated (if NO in step S10), then the process continues to step S5. On the other hand, if it is determined that it is unknown whether the motion image information or the audio information is permitted to be duplicated or not due to a failure in detection of the watermark (if YES in step S10), the type of the picture contained in the demodulated signal Sdm input at that timing, specifically, I picture, P picture, or B picture, is determined (step S11).

Then, it is determined whether or not the picture input at that timing is an I picture in the detection in step S1 (step S12), and if it is determined to be the I picture (if YES in step S12), the picture signal Spic indicative of the I picture is generated and output to the superimposition unit 4. The superimposition unit 4 embeds the received picture signal Spic (that is, picture signal Spic indicating that the still image is decoded from the I picture in the GOP 100 before being decoded) as the watermark in the still image in the decoded signal Sdc, which is decoded by the decoder 3 and input to the superimposition unit 4 at the same timing (step S13), to generate the superimposed signal Smx and outputs it to the down-converter 6, and then, the process continues to step S8.

A specific method for embedding the picture signal Spic in step S13 is explained as follows: for example, a picture signal Spic can be embedded by setting two least significant bits of pixel data at the address of (0, 0) in a still image decoded from an I picture to “1”, setting two least significant bits of pixel data at the address of (0, 0) in a still image decoded from a picture other than the I picture to “0”, setting two least significant bits of pixel data at the address of (0, 1) in the still image decoded from the I picture to “o”, and setting two least significant bits of pixel data at the address of (0, 2) in the still image decoded from an I picture to “1”. As a result, the two least significant bits of the pixel data at the address of (0, 0) in the still image decoded from the I picture are all set to “1”, the two least significant bits of the pixel data at the address of (0, 1) in the still image decoded from the I picture are all set to “0”, and the two least significant bits of the pixel data at the address of (0, 2) in the still image decoded from the I picture are all set to “1”, and thereby the still image decoded from the I picture has a data pattern rarely appearing in typical reproduced still images so that the picture signal Spic can be embedded therein so as to be identified.

Then, it is checked whether or not the decoding process is completed for all the pictures (step S8), and if the process is completed (if YES in step S8), the sequence of the decoding process is ended. On the other hand, if the GOP 100 contains a picture not decoded (if NO in step S8), the process continues to step S2 to perform the above-described decoding process on the picture.

If it is determined that the picture input is not the I picture in the determination in step S12 (if NO in step S12), the process continues to step S8 by passing the above-described embedding (step S13) of the picture signal Spic.

In the determination in step S4, if it is determined, based on the identification information contained at the head of the information sector, that the motion image information and the audio information input in the form of the demodulated information Sdm are not those permitted to be duplicated (if NO in step S4), then the type of the received picture contained in the demodulated signal Sdm is detected as in the processing in step S11 described above (step S5), and it is determined whether the picture is determined to be the I picture or not (step S6).

Then, if the picture is determined to be the I picture in the determination in step S6 (if YES in step S6), the process continues to step S8 bypassing the embedding of the picture signal Spic.

On the other hand, if the picture is determined not to be the I picture in the determination in step S6 (if NO in step S6), one still image decoded from a picture other than the I picture in the GOP 100 before being decoded is selected, or one still image decoded is randomly selected, and the picture signal Spic is embedded in the selected still image as dummy information according to the watermark method in the superimposition unit 4 (step S7) to generate the superimposed signal Smx, the superimposition signal Smx is output to the down-converter 6, and then the process continues to step S8.

Specifically, in the processing in step S7, as shown in FIG. 4, the picture signal Spic indicating that a still image is the still image FG decoded from the I picture is embedded in one of the still images FG reproduced from pictures other than the I picture in the GOP 100 before being decoded (see the second stage in FIG. 4), or randomly embedded in a number of still images FG, the number being associated with the original GOP (see bottom stage in FIG. 4).

Now, a recorder/player according to the first embodiment will be described with reference to FIG. 5.

FIG. 5 shows a recorder/player having a recording function of encoding again the output signal Sed generated through the decoding process in the set-top box SB described with reference to FIGS. 1 to 4 and optically recording the same in an optical disk DK, and a decoding function of decoding the motion image information and the audio information recorded in the optical disk DK according to, for example, the MPEG method through the same process as in the set-top box SB.

As shown in FIG. 5, the recorder/player PR according to the first embodiment is provided with: a pickup 23; a head amplifier 10; a format decoder 11; a decoder 12; a superimposition unit 13; an encoder 14; a recording driver 15; a pulse generator circuit 16; a format encoder 17; an encoder 18 serving as an encoding device; an extraction unit 19 serving as a detecting device; a separation unit 20; a time base correction unit 21; and a CPU 22. The pickup 23, the recording driver 15, the pulse generator circuit 16, the format encoder 17, the encoder 18, the extraction unit 19, the separation unit 20, the time base correction unit 21 and the CPU 22 of which are responsible for the recording function, and the pickup 23, the head amplifier 10, the format decoder 11, the decoder 12, the superimposition unit 13, the encoder 14 and the CPU 22 of which are responsible for the decoding function.

Now, an operation thereof will be described.

First, the operation of the components responsible for the decoding function will be described.

First, the pickup 23 irradiates the optical disk DK having the motion image information recorded therein with a light beam B for information reproduction, receives the reflected light, generates a detection signal Sp varying with the change in the reception intensity thereof, and outputs the detection signal to the head amplifier 10.

Then, the head amplifier 10 amplifies the detection signal Sp with a preset amplification factor to generate an amplified signal Sft, and output the amplified signal to the format decoder 11. The motion image information contained in the amplified signal Sft includes the GOP 100 described above.

Based on the control signal Sfc from the CPU 22, the format decoder 11 interprets the format structure of the motion image information contained in the amplified signal Sft, separates the motion image information from other control information, generates a demodulated signal Sdm similar to that in the set-top box SB, and outputs the demodulated signal to the decoder 12.

Then, based on the control signals Scc and Sdx from the CPU 22, respectively, the decoder 12 and the superimposition unit 13 performs exactly the same processes in the decoder 3 and the superimposition unit 4 in the set-top box SB (specifically, the decoding and the embedding of the picture signal Spic described above with reference to FIGS. 2 to 4), and the superimposition unit 13 generates a superimposed signal Smx containing the motion image information composed of the still image decoded and having the picture signal Spic embedded therein and outputs the superimposed signal to the encoder 14.

Then, based on the control signal Sce from the CPU 22, the encoder 14 performs a demodulation according to the NTSC or the like on the superimposed signal Smx in the same manner as the encoder 7 in the set-top box SB, and outputs an output signal Sed to an external display, speaker, or the like.

Next, the operation of the components responsible for the recording function will be described.

First, the output signal Sed output from the set-top box SB is input to the time base correction unit 21. Then, the time base correction unit 21 performs a time base correction on the output signal Sed to generate a correction signal Std, and outputs the correction signal Std to the separation unit 20.

Next, the separation unit 20 separates the correction signal Std into a luminance signal (Y signal) and a color signal (C signal), and separately outputs the luminance signal and the color signal as a separation signal Ssp to the extraction unit 19.

Then, based on the control signal Scu from the CPU 22, the extraction unit 19 extracts the picture signal Spic contained in the separation signal Ssp as the watermark from the separation signal Ssp, outputs the extracted picture signal Spic to the encoder 18 as it is, and besides the picture signal Spic, outputs the separation signal Ssp after extraction of the picture signal Spic to the encoder 18 as the decoded signal Sdc.

Based on the control signal Scee from the CPU 22 and according to the MPEG method, the encoder 18 re-encodes the decoded signal Sdc by forming the GOP 100 in such a manner that the I picture in the GOP 100 after being encoded is generated from the still image having the picture signal Spic embedded therein in the decoded signal Sdc, generates the demodulated signal Sdm and outputs the demodulated signal to the format encoder 17. In this re-encoding, the pictures in the GOP 100 other than the I picture are generated in the basis of the I picture generated again from the still image decoded from the I picture in the original GOP 100 before being decoded.

In the case where the picture signal Spic is embedded in the still image decoded from a picture other than the I picture in the GOP 100 before being decoded as described above with reference to FIG. 4, the re-encoding results in a new GOP 100 being formed in the basis of an picture (serving as an I picture) other than the I picture in the GOP 100 before being decoded, so that the quality of the image for the motion image information containing the new GOP 100 is degraded.

Then, based on the control signal Scfe from the CPU 22, the format encoder 17 hierarchically formats the demodulated information Sdm according to the format of the MPEG method to generate a formatted signal Sft, and outputs the formatted signal to the pulse generator circuit 16.

Then, the pulse generator circuit 16 generates a drive signal Spl for driving the recording driver 15, the drive signal having an intensity variation associated with the information contained in the formatted signal Sft, and outputs the drive signal to the recording driver 15.

Then, in response to the drive signal Spl, the recording driver 15 generates a laser driving signal Sr for driving a semiconductor laser (not shown) in the pickup 23, and outputs the laser driving signal to the pickup 23. At this time, the laser driving signal Sr has an intensity variation associated with the variation pits (or marks) formed on the optical disc DK when the motion image information contained in the original output signal Sed is recorded in the optical disc DK.

Finally, the semiconductor laser (not shown) in the pick up 23 irradiates the optical disc DK with a light beam B for recording having an intensity variation represented by the laser driving signal Sr, and thereby the pits or marks are formed on the optical disc and the motion image information is recorded.

In parallel with this process, the CPU22 generates the respective control signals described above to control comprehensively the operation of the recorder/player PR.

As described above, in the operations of the set-top box SB and the recorder/player PR according to this embodiment, since the output signal Sed is generated by embedding in a still image the picture signal Spic indicating that the still image is one decoded from the I picture in the GOP 100 as a watermark, and the output signal Sed is re-encoded in the recorder/player PR by using the embedded picture signal Spic, the re-encoding also results in the I picture being generated from the still image decoded from the I picture in the GOP 100 before being decoded, and the other pictures in the GOP 100 can be generated with respect to the I picture generated by the re-encoding. As a result, compared to the re-encoding not using the picture signal Spic, the quality of the motion image information after being re-encoded can be improved.

In addition, since the output signal Sed is generated with the picture signal Spic being embedded in the still image, the picture signal Spic is not lost in the re-encoding.

In addition, since the re-encoding using the picture signal Spic can be accomplished only when the output signal Sed is permitted to be duplicated, the quality of the image after the output signal Sed permitted to be duplicated is re-encoded can be improved.

In addition, since the precise picture signal Spic cannot be used when the output signal is not permitted to be duplicated, the quality of the image for the motion image information cannot be maintained in the re-encoding in the case of illegally duplicating the output signal Sed not permitted to be duplicated, and consequently, the copy of the output signal Sed can be restricted.

In addition, since the picture signal Spic is embedded by digital watermarking, the picture signal Spic can be prevented from being lost in the re-encoding while enhancing the secrecy of the picture signal Spic.

In addition, since the recorder/player PR encodes the output signal Sed again using the picture signal Spic extracted from the output signal Sed, compared to the re-encoding not using the picture signal Spic, the quality of the image for the motion image information after being re-encoded can be improved.

In the structure of the set-top box SB described above (see FIG. 2), the superimposition unit 4 is disposed between the decoder 3 and the down-converter 6. However, the superimposition unit 4 may be disposed not at the position shown in FIG. 2 but between the down-converter 6 and the encoder 7 in FIG. 2 so that the picture signal Spic is input from the decoder 3 to the superimposition unit 4.

In addition, in the embodiment described above, the picture signal Spic is one indicating that the picture before being decoded associated therewith is the I picture. Assuming that the number of pictures in one GOP 100 and the order of the pictures in one GOP 100 in terms of the types thereof are fixed, however, the information indicating that the picture before being decoded associated therewith is a B picture or P picture may be used as the picture signal Spic.

In such a case, only if the picture before being decoded can be determined to be a B picture or P picture, the still image for which the picture before being decoded is the I picture can be specified.

In addition, while in the embodiment described above, the information indicating that the picture currently being decoded is the I picture is used as the picture signal Spic, the picture signal Spic may be information indicating that the picture following the picture currently being decoded is the I picture or that the picture ahead by a preset number of the picture currently being decoded, and superimposed on the still image currently reproduced by decoding.

In this case again, the still image for which the picture before being decoded is the I picture can be specified.

Alternatively, a general-purpose microcomputer may be made to serve as the CPU 5 or 22 by recording a program ready for the operation of the set-top box SB or recorder/player PR in a flexible disc, hard disc, semiconductor memory or the like, and reading and executing the program with the microcomputer.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-133466 filed on Apr. 27, 2001 including the specification, claims, drawings and summary is incorporated herein by reference in its entirety.

What is claimed is:

1. A decoder for generating decoded information by decoding encoded information, comprising:
a detection device for detecting a status of encoding in the encoded information based on the encoded information; and
a generation device for generating the decoded information by embedding status information indicative of the detected status in image information contained in the decoded information.

2. The decoder according to claim 1, wherein
the generation device embeds the status information in the image information only when copy of the encoded information is permitted to be executed.

3. The decoder according to claim 1, wherein
the generation device embeds dummy information different from the status information in the image information only when copy of the encoded information is prohibited from being executed.

4. The decoder according to claim 1, wherein
the generation device embeds the status information in the image information by digital watermarking.

5. The decoder according to claim 3, wherein
the generation device embeds the dummy information in the image information by digital watermarking.

6. A decoder for generating decoded information by decoding encoded information containing copy control information that restricts copy of the decoded information obtained by decoding the encoded information, comprising:
a detection device for detecting a status of encoding in the encoded information based on the encoded information; and
a generation device for generating the decoded information by superimposing status information indicative of the detected status thereon only when the copy control information is an information for permitting the copy to be executed.

7. A decoder for generating decoded information by decoding encoded information containing copy control information that restricts copy of the decoded information obtained by decoding the encoded information, comprising:
a detection device for detecting a status of encoding in the encoded information based on the encoded information; and
a generation device for generating the decoded information by superimposing dummy information different from the detected status information indicative of the detected status thereon only when the copy control information is the copy control information for prohibiting the copy from being executed.

8. The decoder according to claim 1, wherein
the encoded information is compressed motion image information comprising a plurality of compressed still images, and
the status information is type information indicative of the type of the still image.

9. The decoder according to claim 8, wherein
the compressed motion image information is compressed according to an MPEG (Moving Picture Experts Group) method, and
the type information indicates that the still image is an intra-coded picture.

10. A re-encoder for encoding again decoded information generated by a decoder for generating decoded information by decoding encoded information, the decoder comprising: a detection device for detecting a status of encoding in the encoded information based on the encoded information; and a generation device for generating the decoded information by embedding status information indicative of the detected status in image information contained in the decoded information, the re-encoder comprising:
a detection device for detecting status information from the decoded information; and
an encoding device for encoding again the decoded information using the detected status information.

11. A decoding method for generating decoded information by decoding enabled information, comprising:
a detecting process of detecting a status of encoding in the encoded information based on the encoded information; and
a generating process of generating the decoded information by embedding status information indicative of the detected status in image information contained in the decoded information.

12. The decoding method according to claim 11, wherein
in the generating process, the status information is embedded in the image information only when copy of the encoded information is permitted to be executed.

13. The decoding method according to claim 11, wherein
in the generating process, dummy information different from the status information is embedded in the image information only when copy of the encoded information is prohibited from being executed.

14. The decoding method according to claim 11, wherein
in the generating process, the status information is embedded in the image information by digital watermarking.

15. The decoding method according to claim 13, wherein
in the generating process, the dummy information is embedded in the image information by digital watermarking.

16. A decoding method for generating decoded information by decoding encoded information containing copy control information that restricts copy of the decoded information obtained by decoding the encoded information, comprising:
a detecting process of detecting a status of encoding in the encoded information based on the encoded information; and
a generating process of generating the decoded information by superimposing status information indicative of the detected status thereon only when the copy control information is the copy control information for permitting the copy to be executed.

17. A decoding method for generating decoded information by decoding encoded information containing copy control information that restricts copy of the decoded information obtained by decoding the encoded information, comprising:
a detecting process of detecting a status of encoding in the encoded information based on the encoded information; and
a generating process of generating the decoded information by superimposing dummy information different from the detected status information indicative of the detected status thereon only when the copy control information is the copy control information for permitting the copy to be executed.

18. The decoding method according to claim 11, wherein
the encoded information is compressed motion image information composed of a plurality of compressed still images, and
the status information is type information indicative of the type of the still image.

19. The decoding method according to claim 18, wherein
the compressed motion image information is compressed according to an MPEG method, and
the type information indicates that the still image is an intra-coded picture.

20. A re-encoding method for encoding again decoded information generated by a decoder for generating decoded information by decoding encoded information, the decoder comprising: a detection device for detecting a status of encoding in the encoded information based on the encoded information; and a generation device for generating the decoded information by embedding status information indicative of the detected status in image information contained in the decoded information, comprising:
a detecting process of detecting status information from the decoded information; and
an encoding process of encoding again the decoded information using the detected status information.

21. An information recording medium having a decoding program recorded therein so as to be read by a decoding computer included in a decoder that generates decoded information by decoding encoded information, wherein the decoding program causes the decoding computer to function as:
a detection device for detecting a status of encoding in the encoded information based on the encoded information; and
a generation device for generating the decoded information by embedding status information indicative of the detected status in image information contained in the decoded information.

22. The information recording medium according to claim 21, wherein the generation device embeds the status information in the image information only when copy of the encoded information is permitted to be executed.

23. The information recording medium according to claim 21, wherein the generation device embeds dummy information different from the status information in the image information only when copy of the encoded information is prohibited from being executed.

24. The information recording medium according to claim 21, wherein the generation device embeds the status information in the image information by digital watermarking.

25. The information recording medium according to claim 23, the generation device embeds the dummy information in the image information by digital watermarking.

26. An information recording medium having a decoding program recorded therein so as to be read by a decoding computer included in a decoder that generates decoded information by decoding encoded information containing copy control information that restricts copy of the decoded information obtained by decoding the encoded information, wherein the decoding program causes the decoding computer to function as:
a detection device for detecting a status of encoding in the encoded information based on the encoded information; and
a generation device for generating the decoded information by superimposing status information indicative of the detected status thereon only when the copy control information is the copy control information for permitting the copy to be executed.

27. An information recording medium having a decoding program recorded therein so as to be read by a decoding computer included in a decoder that generates decoded information by decoding encoded information containing copy control information that restricts copy of the decoded information obtained by decoding the encoded information, wherein the decoding program causes the decoding computer to function as:
a detection device for detecting a status of encoding in the encoded information based on the encoded information; and
a generation device for generating the decoded information by superimposing dummy information indicative of the detected status thereon only when the copy control information is the copy control information for prohibiting the copy from being executed.

28. The information recording medium according to claim 21, wherein the encoded information is compressed motion image information composed of a plurality of compressed still images, and
the status information is type information indicative of the type of the still image.

29. The information recording medium according to claim 28, wherein the compressed motion image information is compressed according to an MPEG method, and
the type information indicates that the still image is an intra-coded picture.

30. An information recording medium having a re-encoding program therein so as to be read by an encoding computer included in a re-encoder that encodes again decoded information generated by the decoder for generating decoded information by decoding encoded information, comprising: a detection device for detecting a status of encoding in the encoded information based on the encoded information; and a generation device for generating the decoded information by embedding status information indicative of the detected status in image information contained in the decoded information, wherein the re-encoding program causes the encoding computer to function as:
a detection device for detecting status information from the decoded information; and
an encoding device for encoding again the decoded information using the detected status information.

31. A computer data signal embodied in a carrier wave and representing a sequence of instructions, wherein the instructions causes a computer to function as a decoder that generates decoded information by decoding encoded information, the instructions comprising:
a detection step for detecting a status of encoding in the encoded information based on the encoded information; and
a generation step for generating the decoded information by embedding status information indicative of the detected status in image information contained in the decoded information.

32. The computer data signal embodied in a carrier wave and representing a sequence of the instructions according to claim 31, wherein the generation step embeds the status information in the image information only when copy of the encoded information is permitted to be executed.

33. The computer data signal embodied in a carrier wave and representing a sequence of the instructions according to claim 31, wherein the generation step embeds dummy information different from the status information in the image information only when copy of the encoded information is prohibited from being executed.

34. The computer data signal embodied in a carrier wave and representing a sequence of the instructions according to claim 31, wherein the generation step embeds the status information in the image information by digital watermarking.

35. The computer data signal embodied in a carrier wave and representing a sequence of the instructions according to claim 33, wherein the generation step embeds the dummy information in the image information by digital watermarking.

36. A computer data signal embodied in a carrier wave and representing a sequence of instructions, wherein the instructions causes a computer to function as a decoder that generates decoded information by decoding encoded information containing copy control information that restricts copy of the decoded information obtained by decoding the encoded information, the instructions comprising:
a detection step for detecting a status of encoding in the encoded information based on the encoded information; and
a generation step for generating the decoded information by superimposing status information indicative of the detected status thereon only when the copy control information is the copy control information for permitting the copy to be executed.

37. A computer data signal embodied in a carrier wave and representing a sequence of instructions, wherein the instructions causes a computer to function as a decoder that generates decoded information by decoding encoded information containing copy control information that restricts copy of the decoded information obtained by decoding the encoded information, the instructions comprising:
a detection step for detecting a status of encoding in the encoded information based on the encoded information; and
a generation step for generating the decoded information by superimposing dummy information indicative of the detected status thereon only when the copy control information is the copy control information for prohibiting the copy from being executed.

38. The computer data signal embodied in a carrier wave and representing a sequence of the instructions according to claim 31, wherein the encoded information is compressed motion image information composed of a plurality of compressed still images, and
the status information is type information indicative of the type of the still image.

39. The computer data signal embodied in a carrier wave and representing a sequence of the instructions according to claim 38, wherein the compressed motion image information is compressed according to an MPEG method, and
the type information indicates that the still image is an intra-coded picture.

40. A computer data signal embodied in a carrier wave and representing a sequence of instructions, wherein the instructions causes a computer to function as a re-encoder that encodes again decoded information generated by the decoder for generating decoded information by decoding encoded information, comprising: a detection device for detecting a status of encoding in the encoded information based on the encoded information; and a generation device for generating the decoded information by embedding status information indicative of the detected status in image information contained in the decoded information, the instructions comprising:
a detection step for detecting status information from the decoded information; and
an encoding step for encoding again the decoded information using the detected status information.
